(19) United States
(12) Patent Application Publication
(10) Pub. No.: US 2026/0348795 A1
(43) Pub. Date: Nov. 5, 2026

(54) BELT EFFICIENCY SENSING SYSTEM AND METHOD

(71) Applicant: Mide Technology Corporation, Woburn, MA (US)

(72) Inventors: Giovanni Fava, Somerville, MA (US); Sauro Liberatore, Brookline, MA (US); Hamed Dabiri, Melrose, MA (US); Justin Larson, Reading, MA (US); Julian Campanella, Dracut, MA (US); Chris Ludlow, Melrose, MA (US); Fabien Zarka-Arthus, Joué-lès-Tours (FR)

(21) Appl. No.: 19/571,891

(22) Filed: Mar. 19, 2026

Related U.S. Application Data
(60) Provisional application No. 63/799,852, filed on May 5, 2025.

(51) Int. Cl. G01M 13/023; G05B 23/02

(52) U.S. Cl. CPC G01M 13/023; G05B 23/0283

(57) ABSTRACT

A belt speed efficiency sensing system is for a belt driven apparatus including a drive pulley driven by a drive motor and a driven pulley coupled to a load and a belt about the drive pulley and driven pulley. At least one accelerometer is mountable to the belt drive apparatus and outputs vibration data. A processor is configured to execute the plurality of stored instructions to receive the vibration data, convert the vibration data to a vibration frequency domain, determine the speed of each pulley as a function of vibration frequency values, and determine belt speed efficiency as a function of the speed of each pulley and the belt driven apparatus configuration parameters.

### RELATED APPLICATIONS

This application claims benefit of and priority to U.S. Provisional Application Ser. No. 63/799,852 filed May 5, 2025, under 35 U.S.C. §§ 119, 120, 363, 365, and 37 C.F.R. § 1.55 and § 1.78, which is incorporated herein by this reference.

### FIELD OF THE INVENTION

Aspects of the invention are related to belt drive systems.

### BACKGROUND OF THE INVENTION

In a typical belt drive system, there is a drive motor driving a drive pulley, a driven pulley connected to a load (e.g., a generator, HVAC equipment, a washing machine tub/drum, and the like), and a drive belt about the drive pulley and driven pulley.

There is a long felt need to identify drive belt and belt drive system health issues. Some have attempted incorporating sensors into the drive belt itself. See WO 2024/134343; U.S. Pat. Nos. 8,593,291; and 7,494,004, all incorporated herein by this reference, but, sensor survivability is a serious concern.

Using motors with encoders to determine belt efficiency can result in a high cost. Encoders are also difficult to install on existing motors and can be difficult to operate and get readings from. Encoders can also result in unreliable readings.

U.S. Pat. No. 10,488,282, incorporated herein by this reference, uses accelerometers on a belt drive system motor and vibration data to determine belt tension but requires reconfiguring the motor controller which controls the operation of the motor. See also U.S. 2024/1083749; U.S. Pat. No. 7,031,873; WO0219/028269 and EP 0 724 159 A1 incorporated herein by this reference.

### BRIEF SUMMARY OF THE INVENTION

Featured is a new system and method for a belt driven system which determines belt efficiency without motor encoders or the need to reprogram the motor controller, and which preferably does not suffer the survivability problem associated with embedded belt sensors.

Realized in one embodiment is the surprising discovery that vibration data can be used to measure belt speed efficiency. In one example, the vibration data is used to determine the speed (rpm) of the drive and driven pulleys of the belt driven system. With that information, belt efficiency can be determined as can other predictive maintenance parameters. In one example, the frequency content of the system vibration data in the range of the pulleys rotational frequencies is used to establish the pulley rpms. These pulley rpms in conjunction with their respective pulley diameters can then be used to reliably measure the speed of the drive pulley and the speed of the driven pulley.

Featured is a belt speed efficiency sensing system for a belt driven apparatus including a drive pulley driven by a drive motor and a driven pulley coupled to a load and a belt about the drive pulley and driven pulley. The preferred belt efficiency sensing system includes at least one accelerometer mountable to the belt drive apparatus and outputting vibration data. A memory stores a plurality of instructions and belt driven apparatus configuration parameters. A processor is configured to execute the plurality of instructions to receive the vibration data, convert the vibration data to a vibration frequency domain, determine the speed of each pulley as a function of vibration frequency values, and determine belt speed efficiency as a function of the speed of each pulley and the belt driven apparatus configuration parameters.

In one example, the accelerometer is housed in a device along with the memory and processor and mountable to a pulley housing, motor housing, or belt drive apparatus frame. The device can be mounted such that at least one accelerometer axis is mounted perpendicular to a belt drive system shaft. The device may further include a communications module.

In one example, the belt driven apparatus configuration parameters include the radius or diameter of the drive and driven pulleys and the speed of the drive motor. The vibration frequency values used to determine the speed of each pulley are preferably proximate a stored frequency value based on the radius or diameter of the drive and driven pulleys and the speed of the drive motor.

The system may include instructions for estimating the remaining useful life of the belt as a function of belt speed efficiency values measured over time. An ambient temperature sensor can be added to the instructions for estimating the remaining useful life of the belt may include temperature compensating the belt efficiency values measured over time. The system may further include instructions for estimating when a belt needs to be replaced or re-tensioned as a function of the belt efficiency measured over time.

The processor can be further configured to determine any belt misalignment based on the vibration data converted to the frequency domain and/or to estimate the loss of belt tension based on the received vibration data.

Also featured is a belt efficiency sensing method comprising mounting at least one accelerometer to the belt drive apparatus to output vibration data from the apparatus, converting the vibration data to a vibration frequency domain, determining the speed of each pulley as a function of vibration frequency values, and determining belt efficiency as a function of the speed of each pulley and belt driven apparatus configuration parameters.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view of a typical belt driven apparatus;

FIG. 2 is a schematic view of a belt driven apparatus including a drive pulley and a driven pulley;

FIG. 3 is a schematic view of the test rig of FIG. 2 showing the drive motor and the load;

FIG. 4 is a schematic block diagram showing the primary components associated with a belt efficiency sensing system for the belt driven apparatus of FIGS. 1-3;

FIG. 5 is a schematic view showing a device housing for the belt efficiency sensing system components of FIG. 4;

FIG. 6 is a schematic view showing the device of claim 5 mounted to a motor mount of the belt driven apparatus of FIGS. 2-3;

FIG. 7 is a graph showing vibration data for three axes of the accelerometer of FIG. 4;

FIG. 8 is a flow chart showing the primary steps associated with a belt efficiency sensing method for a belt driven apparatus and also showing the primary programing steps and algorithms associated with the processor of FIG. 4;

FIG. 9 is a graph showing a portion of the vibration data of FIG. 7 converted to a frequency domain;

FIGS. 10A and 10B show a belt driven apparatus with different diameter drive and driven pulleys;

FIG. 11 shows the output of a device mounted to the apparatus of FIG. 10;

FIGS. 12A-12B show the output when two devices are used;

FIG. 13 is a table showing exemplary values of belt driven apparatus configuration parameters;

FIG. 14 is a table showing the results of a trained machine learning belt system conditions output;

FIG. 15 is a plot of the probability density function of a pair of acceleration signals, one where the belt is loose (solid) and one where the belt is taught dash) used in the JSD calculation to estimate belt tension; and

FIG. 16 is a plot of a FFT on a pair of acceleration signals, one where the pulleys are aligned (solid line with circle markers) and one with misalignment (solid line with star markers) where the FFT peaks for misalignment condition shift to the left and right for lower and higher frequency peaks respectively.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

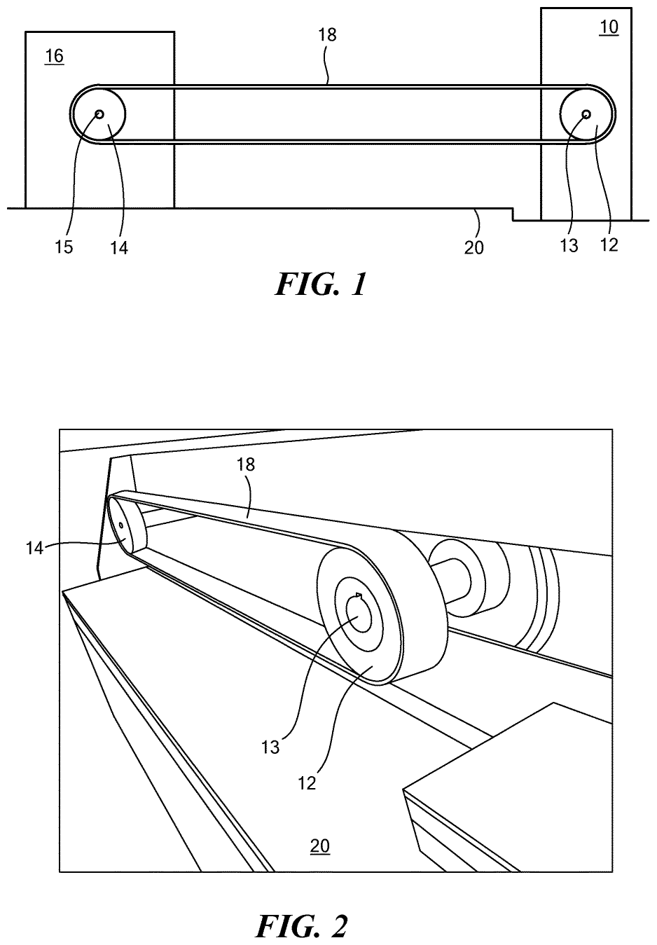

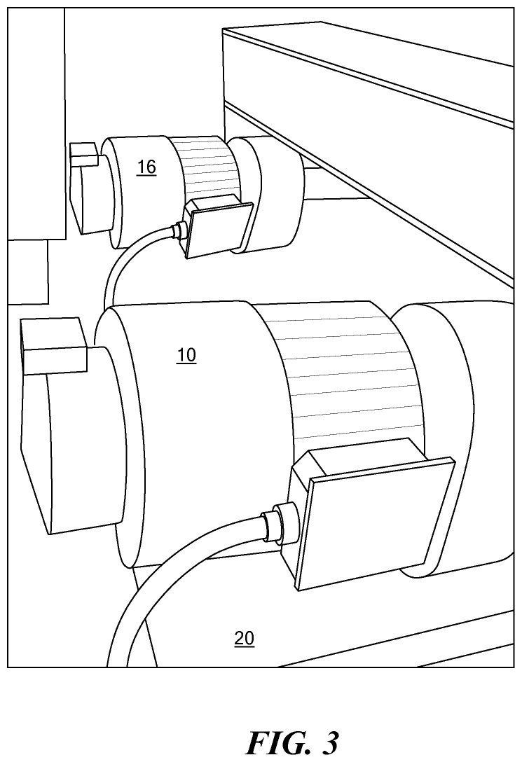

In FIG. 1, drive motor 10 drives drive pulley 12 which in turn drives driven pulley 14 of load 16 via belt 18. In FIG. 1, the pulleys 12 and 14 are shown as having the same diameter. However, the pulleys could have different diameters (e.g., the drive pulley could be larger than the driven pulley or vice versa). Load 16 may be a generator, HVAC equipment, a compressor, a washing machine tub/drum, or the like. Such a belt driven apparatus may include a static frame 20 or the like. FIGS. 2-3 show a testing rig developed by the applicants.

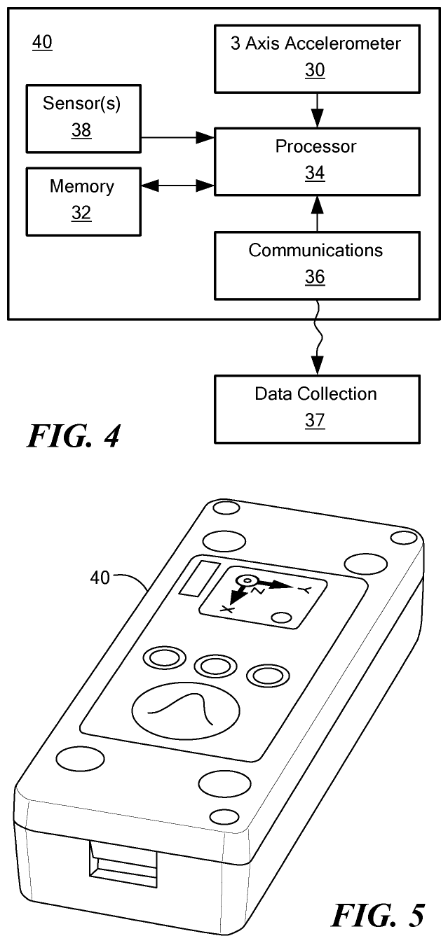

FIG. 4 depicts the primary components associated with an example of a belt efficiency sensing system. Three axis accelerometer 30 is mountable to belt driven apparatus (FIG. 1) (mountable to frame 20, a motor housing, a pulley housing, or the like). A single axis accelerometer could also be used. Preferably, at least one accelerometer axis is mounted perpendicular to a belt drive system shaft (e.g., 13, 15, FIG. 1) because the inherent eccentricity of the pulley and shaft system will show up as a vibration in the system due to the force-generating effect of centripetal acceleration on the pulley which is applied perpendicular to the shaft.

Memory 32 includes stored therein a plurality of instructions (e.g., algorithms) for computational subsystems, one or more processors, or the like. Also stored are belt driven apparatus configuration parameters (e.g., the radius or diameter of the drive and driven pulleys, the speed of the drive motor, and the like). Processor 34, FIG. 1 (e.g., a microprocessor, application specific integrated circuit, controller, computer, or the like) is configured to execute the stored instructions to receive raw vibration data from accelerometer 30, convert the vibration data to a vibration frequency domain, determine the speed of each pulley 12, 14 (FIG. 1) as a function of vibration frequency values, and determine belt 18 efficiency as a function of the speed of each pulley and the stored belt driven apparatus configuration parameters (e.g., pulley radius or diameter, motor speed, and the like).

Communications module 36 is configured to provide belt efficiency and other data to the cloud, another computer, or the like. Bluetooth or LoRa communication techniques/technologies can be used. Module 36 can also be used to interface with the components of the system shown in FIG. 4.

Environmental sensor data, such as temperature sensors, humidity sensors and the like, 38 provides information to processor 34 and the stored instructions executed by the processor may be configured to use that information to estimate remaining useful life and other predictive maintenance parameters of the belt. In this way, when a given belt needs to be replaced or tensioned can be estimated.

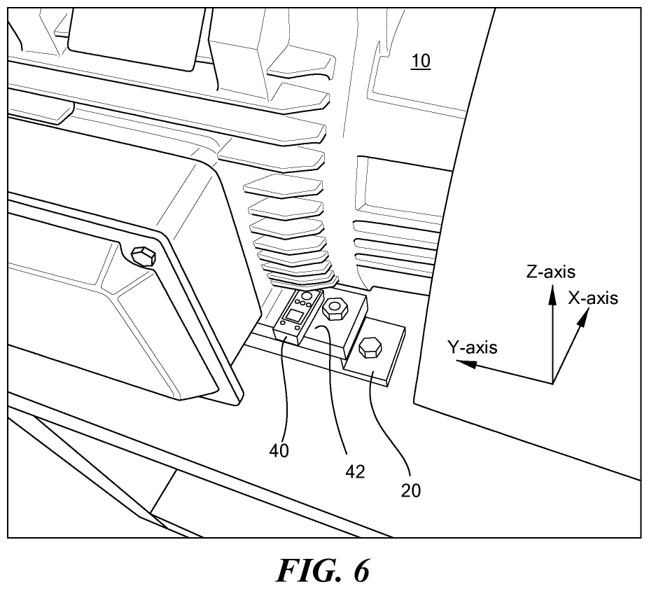

FIG. 5 shows a small housing package 40 for the components of FIG. 4 for mounting to a belt drive apparatus. Not all the components of FIG. 4 need be housed in the mountable package. The memory or memories, the processor or processor functionality, for example, can be distributed amongst several devices or systems (including the cloud). FIG. 6 shows package 40 mounted to a motor 10 mount 42 itself mounted to a system frame 20. In some instances, two or more such devices (40) may be used, for example, one proximate the drive pulley and one proximate the driven pulley. The Z-axis of the accelerometer, in this example, is mounted perpendicular to the motor 10 driveshaft 13. Device 40, FIG. 5 may use wired power and be configured to constantly collect data from a three axis DC accelerometer which measures acceleration of a motor housing to detect the frequency of shaft rotation. Other power sources include batteries or energy harvesting. The device may include an integrated temperature sensor to measure ambient temperature. Other sensors could be used, for example, humidity, pressure, light, and/or current sensors. A sensor connected to the drive motor can be used to detect the electrical power input into the system.

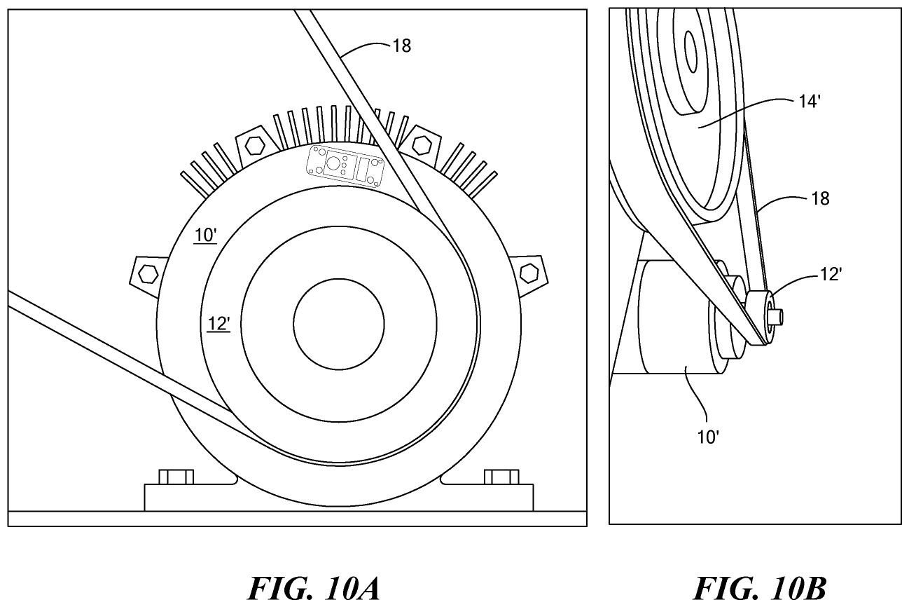

The processor onboard device 40 computes a fast Fourier transform of the raw acceleration data in each axis and the resulting FFT or identified peaks can be sent to a data collection subsystem or directly to the cloud. The data collection subsystem 37, FIG. 4 can be configured to compile results from multiple sensors 40 and to upload data to the cloud. Beneficial results are determining belt efficiency, detecting belt damage, power transmission, belt remaining life, and the ability to provide maintenance recommendations. The device as shown in FIG. 10 can be mounted to the static system frame (using magnetic mounts, adhesives, or fasteners) which is a simple deployment for the device onto the system. Belt efficiency values can then be detected from vibration in the static frame. In one example, device 40 recorded vibration data at 4,000 Hz, the Z-axis is vertical and perpendicular to the motor shaft, and the Y-axis is parallel to the motor shaft. Device 40 can be manufactured at a low cost and is simple and easy to deploy.

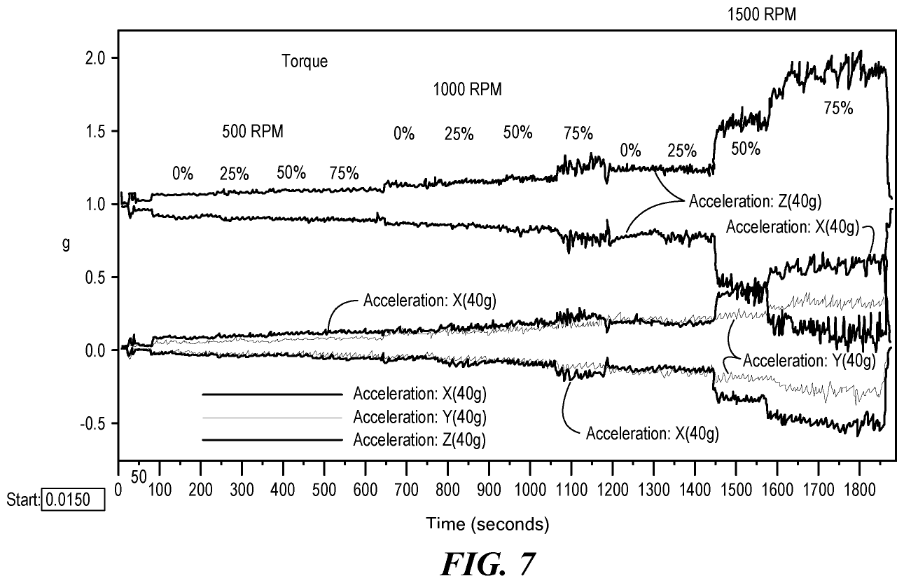

FIG. 7 shows the raw vibration data output by accelerometer 30, FIG. 4 over time and motor 10 revolutions per minute for each accelerometer axis. The vibration data may be produced by vibration of one or more pulleys, the belt, and the like.

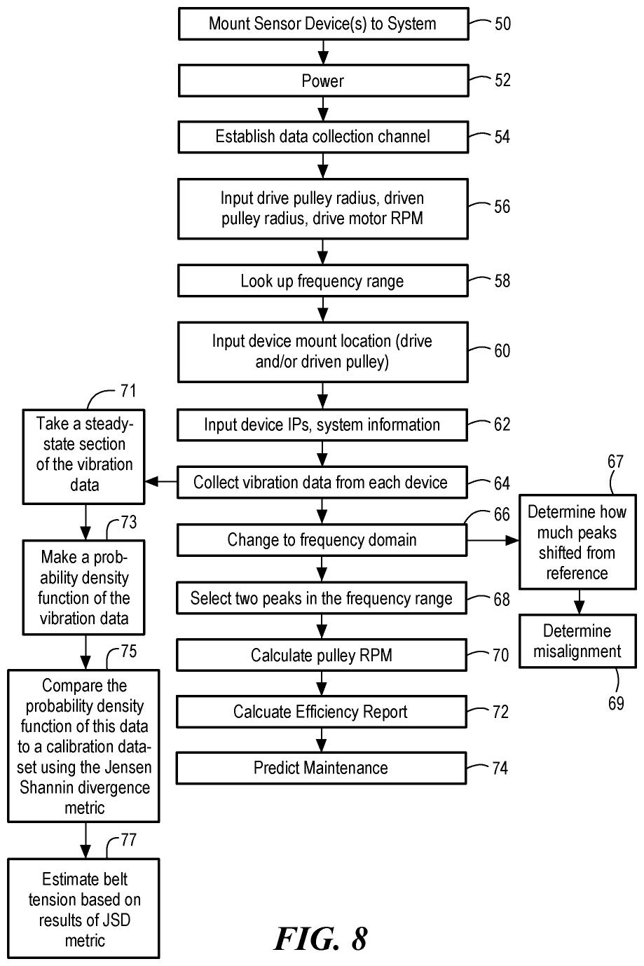

FIG. 8 describes, in one example, the primary functions carried out by processor 34, FIG. 4 and a method of the disclosure.

In steps 50-52, belt efficiency sensing system is mounted to a belt driven apparatus pulley housing, motor housing, motor mount, system frame, or the like and powered on. In one example, power is supplied by a wired connection. Battery or other power supplies may be used. A data collection channel is then established, step 54.

The drive and driven pulley radius, and drive motor speed (rpm) are then input (e.g., via an app, online dashboard, or other interface) and stored in memory 32, FIG. 4 as belt driven apparatus configuration parameters, step 56. The drive motor's RPM can be determined automatically, in some examples. A frequency range for a given belt driven apparatus configuration is also stored, step 58 as is the device mount location, step 60, and device identifiers and belt driven apparatus system information, step 62.

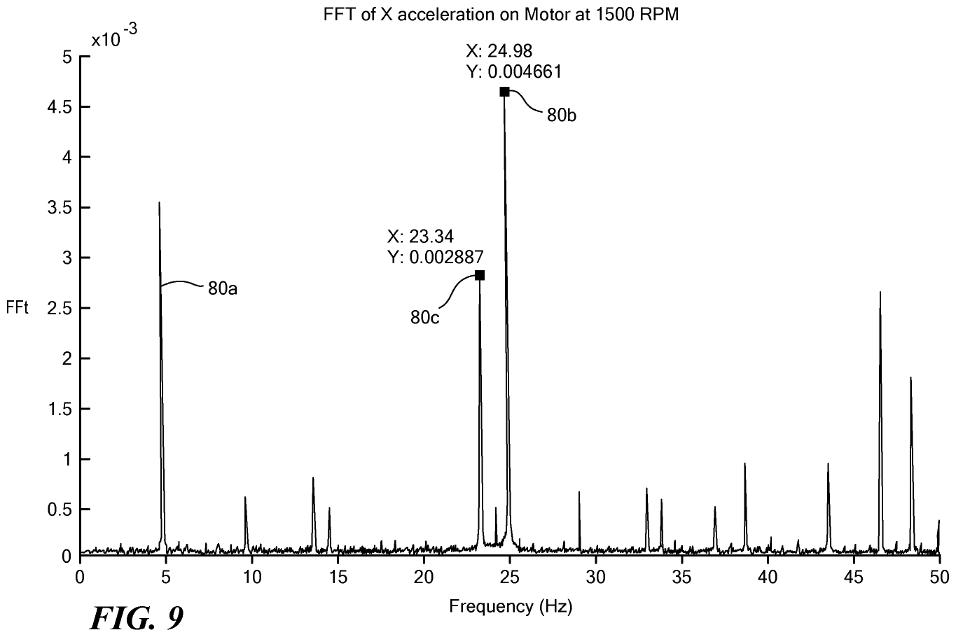

Vibration data is then collected for each device, step 64 (see FIG. 3) which is converted to a frequency domain, (using, for example, a fast Fourier Transformation of the raw acceleration data output by the accelerometer), step 66. See also FIG. 9.

In this particular example, the pulley diameter ratio is 1:1. Two peak frequencies 80b, 80c, FIG. 9 proximate a selected frequency range (here 25 Hz) are selected, step 68, FIG. 8. The selected frequency range is based on the stored belt driven apparatus configuration parameters such as the radius or diameter of the drive and driven pulleys, the speed of the drive motor, and the like. The drive pulley frequency range is determined by a user (or sensor, or other) input of estimated drive pulley rpm; as an example, in FIG. 9 the drive system is estimated to be 1500 rpm, which corresponds to 25 Hz. The algorithm finds the highest magnitude peak nearest that target. Once the peak is found, the pulley ratio is used to determine the frequency range for the driven pulley; for example, in a 1:1 pulley ratio, the algorithm would search for other peaks in frequency close to but less than the 25 Hz for the driven pulley. In the example of a 2:1 pulley ratio, where the driven pulley is larger, the algorithm would search for high magnitude frequencies close to but less than 12.5 Hz.

To find these peaks without being given the frequency range of the belt driven system, the pulley's harmonic vibrations can be used. The rotating pulleys will excite (vibrate) the structure they are mounted to at frequencies that are of integer multiples of the base rotation frequency (2×, 3×, 4× . . . ). These vibrations from both pulleys are measured by the accelerometer, and then when the vibration signal is converted to the frequency domain, those harmonic frequencies can be seen. The peaks in the FFT are found, and then only peaks that have another integer multiple peaks are kept. In this case, the drive pulley, which has a 25 Hz rotational frequency, has an accompanying peak at 50 Hz, which is exactly double its base frequency. Once all of the base frequency peaks have been found, the pulley ratio and magnitude of the peaks in the FFT can be used to find the correct pair of frequencies that have both high magnitude of vibration and a close ratio to the pulley ratio. In the case of the example on FIG. 9, there is a peak 80a at 5 Hz with multiple harmonics that come off of it, but since it is at ⅕^{th} the frequency (5 Hz vs 25 Hz) of the drive motor's vibration, when they are expected to be at similar frequencies, that peak is not chosen, but the peak 80c at 23.34 Hz is chosen instead due to its high magnitude, harmonic frequency at 46.68 Hz and proximity to the drive peak while the pulley ratio is 1:1.

These two frequency peaks, 80c, 80b, FIG. 9 are used by the processor to determine the speed of each pulley 12, 15, FIG. 1 (which also corresponds to the speed of motor 10 and load 16). In the specific case of FIG. 9, the peak with the smaller amplitude (here peak 80c) represents the speed of the driven pulley 14, FIG. 1 and the peak with the larger amplitude (here peak 80b) represents the speed of the drive pulley 12, FIG. 1 as follows:

Pulley rpm=(Detected Frequency)×(60 rpm/1 Hz) (1).

Here the driven pulley rpm is 23.34×60 or 1,400 rpm and the drive pulley rpm is 24.98×60 or 1,498 rpm. See step 70, FIG. 8. This result is due to slippage of belt 18 on pulley 14, FIG. 1 (and pulley 12).

Now that each pulley's speed is calculated, step 72, FIG. 8, belt efficiency can be determined and reported (see communications module 36, FIG. 4) as follows:

Belt Speed Efficiency=(Driven Pulley Diameter/Drive Pulley Diameter)×(Driven Pulley rpm/Drive Pulley rpm) (2).

Pulley speed can also be determined as follows:

Linear Tangential Velocity of Pulley=(Detected Frequency)*(2π)*(pulley radius), (3).

And: Belt Efficiency=Tangential Velocity (driven pulley)/Tangential Velocity (drive pulley) (4).

Note that usually the drive pulley 12 speed is the same as the speed of motor 10 and the driven pulley 14 speed is the same as the speed of load 16.

A wireless (e.g., Bluetooth (or LoRa)) connection can be established between the belt efficiency device and data collection functionality 37, FIG. 4. The user may interface with software inputs to input into the device via data collection functionality 37 each pulley's radius and the drive motor's rpm range. Further information can include whether a device is connected to the drive or driven pulley.

Preferably, the processing takes a fast Fourier transform of 5 to 150 seconds of data from each device and picks out the peaks in the frequency of interest range from each accelerometer. A 50 second sample is ideal and yields a 0.02 hz resolution. A 10 second sample yields a 0.1 hz resolution. A 100 second sample yields a 0.01 hz resolution. The one to two peaks of interest of the FFT correspond to the rpm of the pulley(s) that the devices are connected to. One to two rpms can be reported to the data collection subsystem after Equations 1 or 2 are solved. Once pulley rpm data is present at the data collection subsystem, the efficiency can be calculated as discussed above with reference to Equations 2 or 4.

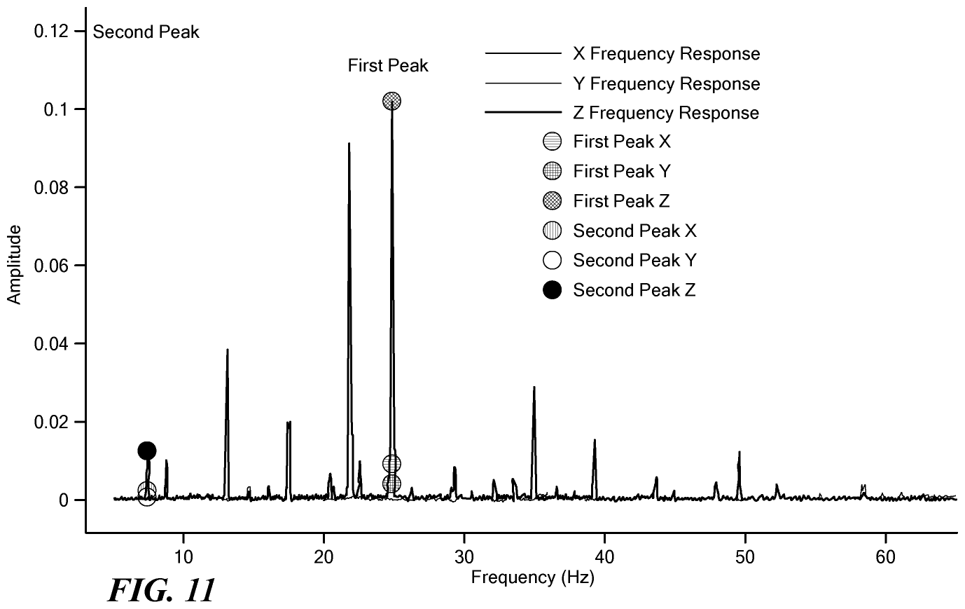

In an exemplary system with a 620:190 pulley system, device 40, FIG. 5 is placed on the drive motor 101, FIGS. 10A-10B near the drive pulley 121. The user inputs the pulley ratio between the drive pulley which is 620 mm:190 mm from the driven:drive pulleys. The user then inputs the estimated RPM for the drive pulley, in this case 1500 RPM. Device 40 records the vibration data from the system for 50 seconds. The data is processed with an FFT to show the frequency content of the vibration signal. The algorithm then takes the input RPM estimate of 1500 RPM and converts that value to frequency (1500 RPM=25 Hz. 1500/60=25). The algorithm looks at the FFT in the range of 5% of 25 Hz (23.75 Hz to 26.25 Hz). In this range it looks the highest magnitude peak in the FFT when summing the X, Y, and Z values (each axis has its own FFT, then they are combined). See FIG. 11. In the case of the example above, the frequency with the highest magnitude in the FFT with all 3 axes is 24.80 Hz, that is now the drive pulley frequency. Once the drive pulley frequency is found that value is used to search for the driven pulley frequency range. The target driven frequency is (drive pulley frequency)/(Pulley ratio). When numbers are plugged in the previous formula becomes (24.8Hz)/(620/190)=7.6 Hz. The algorithm then searches a frequency range 15% less than the target and 5% greater for the highest magnitude peak. This yields a range of 6.46 Hz to 7.98 Hz to search. In this case the largest magnitude peak in this frequency range is at 7.32 Hz which converts to 439.2 RPM for the driven pulley. The belt speed efficiency is then calculated by taking the ratio of pulley RPM multiplied by the pulley ratio. That formula is (439.2/1488)*(620/190)=0.9632=96.32% belt speed efficiency.

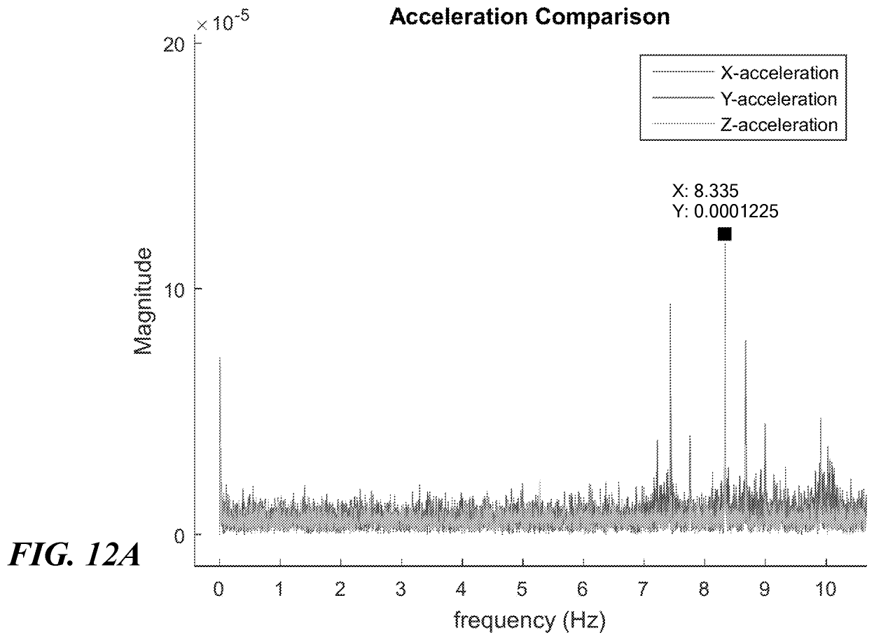

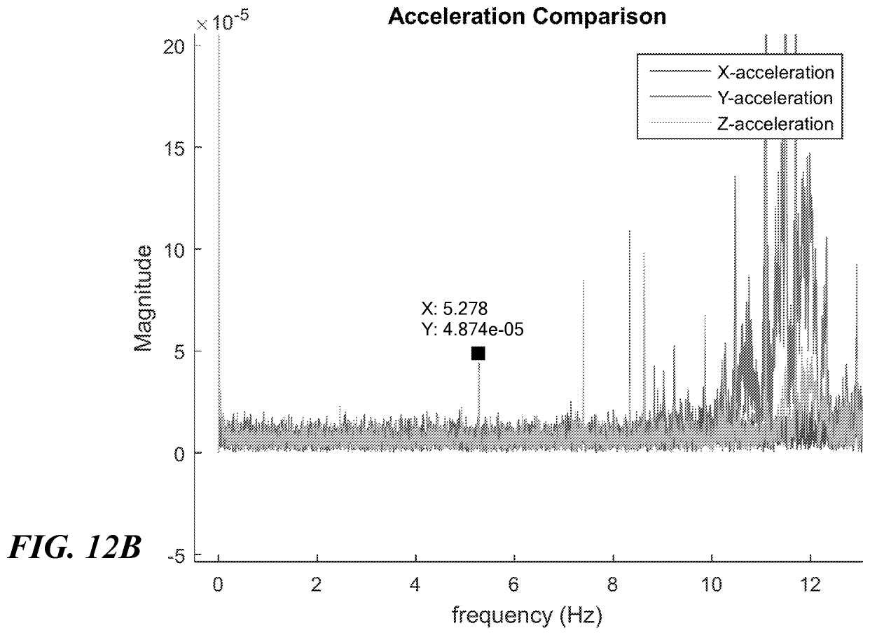

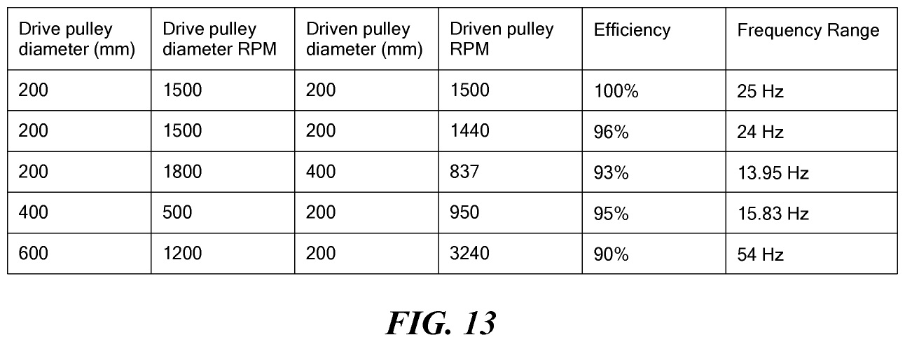

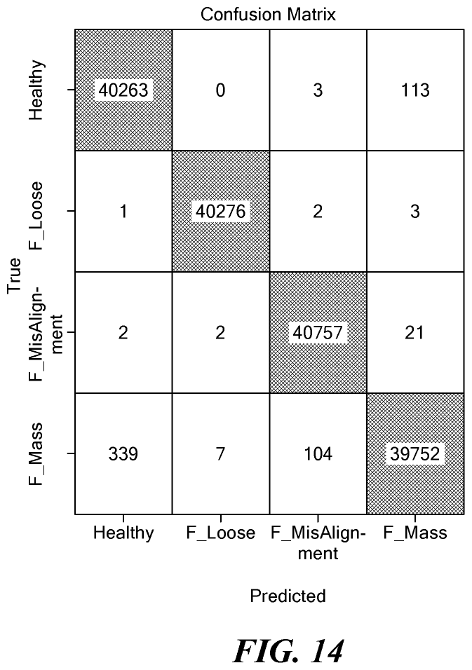

In some examples, two sensor devices 40, FIG. 5 are used. The output from a device placed on the driven system is shown in FIG. 12A and the output of a device placed on the drive system is shown in FIG. 12B. The algorithm works in the same way as described above. In this system the pulley ratio is 0.896 (231 mm for driven pulley, 207 mm for the drive pulley). In this case there is overlap in the two search regions for finding the pulley frequencies, as a result once the drive frequency is identified, that frequency content from that range is removed from consideration when looking for the driven pulley RPM.

In the edge case where the drive and driven pulley frequencies are within less than 5% of each other, the drive RPM can be determined is by taking the efficiency formula (driven pulley RPM)/(drive pulley RPM)* Pulley ratio=efficiency, and if the efficiency is less than 1, than the efficiency is what the algorithm initially calculated was correct, and if the efficiency is greater than 1, the algorithm swaps the values for the driven and drive pulleys.

The data shown in FIG. 12A is collected from the FFT of the vibration from the driven pulley and the greatest peak is at 8.335 Hz. The inputs for the system are 500 RPM for the drive pulley with a 1.5 pulley ratio. Due to the lack of prominent peaks in the FFT data on the left, a second sensor near the driven pulley is used. The data shown above in FIG. 12B is the FFT from the driven side showing a peak frequency at 5.278 in the frequency range of choice derived by taking the drive frequency and dividing by the pulley ratio. In this case the pulley ratio is 1.5 (300 mm:200 mm). Based on the efficiency equations described above the efficiency of this system would be calculated to be (5.278/8.335)*(1.5)=0.9499=94.99% efficiency.

In summary, the algorithm processes the data from the drive system to find the drive frequency, but if the system is not mechanically coupled, and another prominent peak cannot be found where expected, the algorithm uses another device on the driven system to find that frequency.

The same FFT used to find and calculate the rotational speed of the driven and driven pulleys can also be used to find the misalignment of those two pulleys. Misalignment is defined as the angle between the rotational axis of a pulley, and the ideal path of the belt. In a perfectly aligned condition, the pulley's rotational axis will be perpendicular to the ideal path of the belt, meanwhile any deviation from this perpendicularity is defined as misalignment. In a given belt driven system, one pulley can have more misalignment than the other pulley. In FIG. 8 at step 67 by analyzing how much the drive pulley and driven pulley peaks have shifted, misalignment of the two pulleys can be determined, step 69.

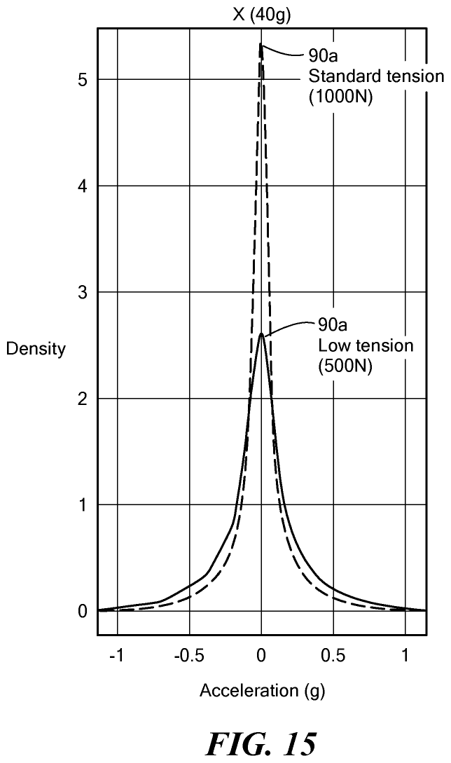

For detecting misalignment, the acceleration signals are collected. An FFT analysis performed to convert time domain time series to frequency domain data. The same method described for detecting FFT peaks corresponding to drive and driven pulleys is used. In case of misalignment, the dive and driven peaks shift in opposite direction. More specifically, the lower frequency peak shifts to left while the higher frequency peak shifts to the right. See FIG. 15 where peak 95a represents the ideal pulley alignment, while peak 95b shows the results of a misaligned pulley with a difference of approximately 1 Hz. This FFT change pattern is not observed for any other fault condition.

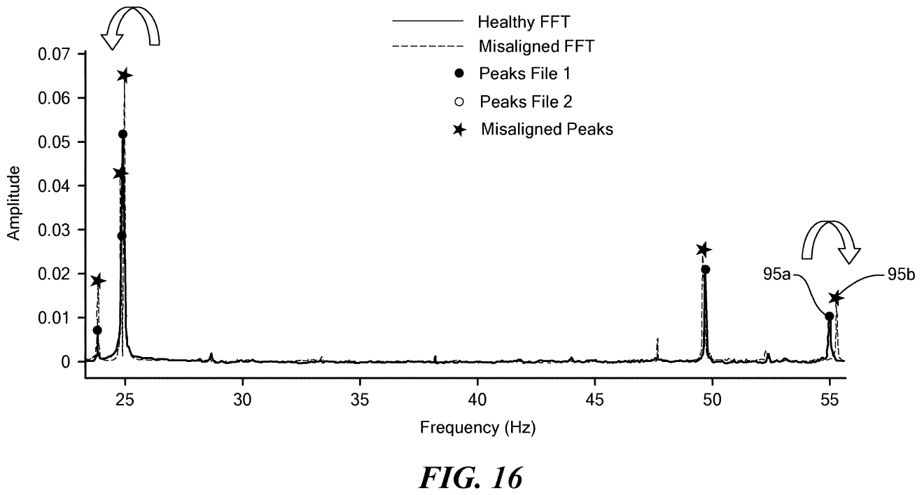

For one or more of the measurement axes perpendicular to the axis of rotation of the drive or driven pulley, the raw acceleration signal can also be used to estimate the loss of belt tension. This method first removes transient data from the machine start-up, or any changes in operation to get the steady state signal, step 71, FIG. 8. Then a 90-second (other time lengths can be used) section from the middle of the remaining steady-state acceleration signal is used for Jensen-Shannon divergence (JSD) analysis. A kernel density estimation (KDE) procedure is then applied to the trimmed (90-second) data, producing a probability density function (PDF) that characterizes the vibration behavior under each belt tension, step 73. These PDFs serve as the statistical representation of the system's dynamic response. See FIG. 16 which shows the comparison between a system with 1000 newtons of belt tension (dashed line 90a), and an under-tensioned system with 500 newtons of belt tension (line 90b), which shows a widening of the peak with decreased belt tension.

To quantify differences between belt tensions, particularly relative to a selected reference condition such as the highest-tension state, which is the initial tension, the method preferably computes Jensen-Shannon divergence (JSD) metric, step 75 between the corresponding PDFs, which is a single number that corresponds to the relative change in tension of the belt. Decreases in belt tension specifically manifest as broadening of the acceleration distribution, causing these divergence values to increase relative to the baseline. JSD is implemented due to its symmetry, bounded range, and robustness to noise. By tracking the change in JSD, the system can detect tension changes, rank conditions by similarity to the reference, and establish thresholds for identifying when belt tension deviates beyond acceptable limits, step 77.

To implement this belt tension monitoring method for a given belt driven system, a baseline test should be performed. First, vibration signals should be collected for a sufficiently long period (90 seconds) for the base line (initial and highest belt tension). Then, belt tension is decreased, for example by decreasing the distance between drive and driven pulleys. The vibration signals are recorded. These steps could be repeated for at least three cycles of tensioning and de-tensioning the belt driven system (the more, the better). JSD will be calculated for the collected data, and then JSD is plotted vs belt tension. By driving a fitted line (preferably linear line), and finding the line equation, belt tension for any other JSD values could be estimated over time. Once the machine is operating, JSD analysis is performed on the acceleration signal form one or more of the axes on the sensor, and then the resulting value has a corresponding belt tension estimate based on the calibration performed.

The belt's remaining useful life and predictive maintenance parameters can be calculated by looking at the change of belt speed efficiency and belt tension over time along with inputs from other environmental sensors and operational parameters. Other environmental sensors may include sensors for humidity, temperature, pressure, light or current. Other operational parameters may include misalignment, shock events, system vibration levels and number of belt rotations. Future estimates of when the belt should be replaced or re-tensioned can also be estimated. See step 74, FIG. 8. Belt speed efficiency is largely dependent on how much frictional force there is between the pulleys and the belt. This frictional force is influenced by how much tension there is in the belt, and this tension is a function of how much the belt is resisting being stretched to its current state. This resistance to change (tension) is affected by wear in the belt which makes the belt itself weaker, and by the temperature of the belt, where a warmer belt will want to stretch more. The purpose of compensating for temperature is that it has a direct effect on the degradation of the belt where the higher the temperature, the more mass loss, and damage in the belt.

In another example, if the number of belt cycles is monitored or estimated, belt efficiency values over time can be combined with the number of belt cycles to determine a belt's remaining useful life. For example, a belt with a lower efficiency will wear faster than a belt with higher efficiency values. To estimate the remaining useful life of the belt, a few user inputs are needed: radius of the drive and driven pulleys, length of the belt, number of belt ribs, belt material and a drive system power estimate. In the case of this example, the drive and driven pulley are 200 mm in diameter, the belt is 3 meters long, has 6 ribs and is made of rubber with aramid fibers, and the power of the drive motor is 15 kilowatts. The drive and driven pulley RPM are obtained from the acceleration sensor, in the case of this example, 1500 RPM, and 1400 RPM. Given the pulley diameter and belt length the formulas in the previous work on patent WO2025122075 can be implemented, and an estimate of mass lost in the system can be calculated. A given belt is designed to survive a certain amount of wear, which is calculated as mass loss, for the given belt 5% mass loss is the maxim allowable before the belt must be replaced.

The formula for mass loss provides a value based on the time that the belt is run and that time value is based on the time between recordings. The number generated by that formula is the resulting amount of wear that the belt has seen in the measurement period. This number is added to the previous total mass loss on the belt to calculate an updated total mass loss on the belt. If the sensor and belt are newly installed, the total wear on the belt starts at zero, and each measurement period adds a little more wear to the total until the belt mass loss reaches 5% of the belt's initial mass, where the user will be sent a warning that their belt has reached its maximum designed lifespan, and that the belt should be replaced.

In this way, the new system and method for belt driven systems determines belt efficiency without motor encoders or the need to reprogram the motor controller. The survivability problem associated with embedded belt sensors is not a concern. Vibration data is used to measure belt speed efficiency by using the vibration data to determine the speed of the drive and driven pulleys of the belt driven system and with that information belt efficiency can be determined as can other remaining useful life and predictive maintenance parameters. Preferably, the frequencies of two vibration peaks in a given frequency range(s) are used to reliably estimate the speed of the drive pulley and the speed of the driven pulley.

FIG. 10 is a table showing stored belt driven apparatus configuration parameters, in one example, for a set of belt driven apparatus. The table can be used as a lookup table for the system computational means or the values of the table can reside as equations or graphs stored in memory.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A belt speed efficiency sensing system for a belt driven apparatus including a drive pulley driven by a drive motor and a driven pulley coupled to a load and a belt about the drive pulley and driven pulley, the belt efficiency sensing system comprising:
at least one accelerometer mountable to the belt drive apparatus and outputting vibration data;
a memory storing a plurality of instructions and belt driven apparatus configuration parameters; and
a processor configured to execute the plurality of instructions to:
receive the vibration data,
convert the vibration data to a vibration frequency domain,
determine the speed of each pulley as a function of vibration frequency values, and
determine belt speed efficiency as a function of the speed of each pulley and the belt driven apparatus configuration parameters.

2. The system of claim 1 in which the accelerometer is housed in a device along with the memory and processor and mountable to a pulley housing, motor housing, or belt drive apparatus frame.

3. The system of claim 2 in which the device is mounted such that at least one accelerometer axis is mounted perpendicular to a belt drive system shaft.

4. The system of claim 2 in which the device further includes a communications module.

5. The system of claim 1 in which the belt driven apparatus configuration parameters include the radius or diameter of the drive and driven pulleys and the speed of the drive motor.

6. The system of claim 5 in which the vibration frequency values used to determine the speed of each pulley are proximate a stored frequency value based on the radius or diameter of the drive and driven pulleys and the speed of the drive motor.

7. The system of claim 1 further including instructions for estimating the remaining useful life of the belt as a function of belt speed efficiency values measured over time.

8. The system of claim 7 further including an ambient temperature sensor and the instructions for estimating the remaining useful life of the belt includes temperature compensating the belt efficiency values measured over time.

9. The system of claim 7 further including instructions for estimating when a belt needs to be replaced or re-tensioned as a function of the belt efficiency measured over time.

10. The system of claim 1 in which the processor is further configured to determine any belt misalignment based on the vibration data converted to the frequency domain.

11. The system of claim 1 in which the processor is further configured to estimate the loss of belt tension based on the received vibration data.

12. A belt efficiency sensing method for a belt driven apparatus including a drive pulley driven by a drive motor and a driven pulley coupled to a load and a belt about the drive pulley and driven pulley, the belt speed efficiency sensing method comprising:
mounting at least one accelerometer to the belt drive apparatus to output vibration data from the apparatus;
converting the vibration data to a vibration frequency domain;
determining the speed of each pulley as a function of vibration frequency values; and
determining belt efficiency as a function of the speed of each pulley and belt driven apparatus configuration parameters.

13. The method of claim 12 in which the accelerometer is mounted such that at least one accelerometer axis is mounted perpendicular to a belt drive system shaft.

14. The method of claim 12 in which the belt driven apparatus configuration parameters include the radius or diameter of the drive and driven pulleys and the speed of the drive motor.

15. The system of claim 14 in which the vibration frequency values used to determine the speed of each pulley are proximate a stored frequency value based on the radius or diameter of the drive and driven pulleys and the speed of the drive motor.

16. The system of claim 12 further including estimating the remaining useful life of the belt as a function of belt efficiency measured over time.

17. The method of claim 16 in which estimating the remaining useful life of the belt includes temperature compensating the belt efficiency values measured over time.

18. The method of claim 14 further including estimating when a belt needs to be replaced or re-tensioned as a function of the belt efficiency values measured over time.

19. The method of claim 12 in which the processor is further configured to determine any belt misalignment based on the vibration data converted to the frequency domain.

20. The method of claim 12 in which the processor is further configured to estimate belt tension based on the vibration data.
